(19) United States
(12) Patent Application Publication
(10) Pub. No.: US 2024/0278503 A1
(43) Pub. Date: Aug. 22, 2024

(54) RECOATING TECHNIQUES FOR POWDER-BASED ADDITIVE FABRICATION AND RELATED SYSTEMS AND METHODS

(71) Applicant: Formlabs, Inc., Somerville, MA (US)

(72) Inventors: Hayley C. Whelan, Somerville, MA (US); Joshua Bradshaw, Cambridge, WA (US)

(73) Assignee: Formlabs, Inc., Somerville, MA (US)

(21) Appl. No.: 18/581,519

(22) Filed: Feb. 20, 2024

Related U.S. Application Data
(60) Provisional application No. 63/576,585, filed on Feb. 21, 2023.

(51) Int. Cl. B29C 64/386; B29C 64/153; B29C 64/205; B29C 64/268; B33Y 10/00; B33Y 30/00; B33Y 50/00

(52) U.S. Cl. CPC B29C 64/386; B29C 64/153; B29C 64/205; B29C 64/268; B33Y 10/00; B33Y 30/00; B33Y 50/00

(57) ABSTRACT

Methods and systems of producing a 3D object on a selective laser sintering device are described. The method involves retaining a first layer of powder of uniform thickness on a build platform, scanning a laser beam along a predetermined path to consolidate portions of the first layer of powder to form a cross-section of the 3D object, and depositing a second layer of powder of uniform thickness on top of the first layer prior to completing the scanning process. The powder deposition device is moved from one end of the build platform to the other, depositing the second layer on both the loose powder and the previously consolidated powder.

### CROSS REFERENCE TO RELATED APPLICATIONS

The present application claims the benefit of under 35 U.S.C. § 119(e) of U.S. Provisional Patent Application No. 63/576,585, filed Feb. 21, 2023, titled “Stereolithography 3-Dimensional printer with an electrophoretic display panel,” which is hereby incorporated by reference in its entirety.

### FIELD OF THE INVENTION

The present disclosure relates generally to systems and methods of additive fabrication (e.g., 3-dimensional printing), and more specifically, to designs and techniques for improving the performance and lifespan of additive fabrication devices.

### BACKGROUND

Additive fabrication, e.g., 3-dimensional (3D) printing, provides techniques for fabricating objects, typically by causing portions of a building material to solidify at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, selective laser sintering or combinations thereof. Many additive fabrication techniques build parts by forming successive layers, which are typically cross-sections of the desired object. Typically each layer is formed such that it adheres to either a previously formed layer or a substrate upon which the object is built.

In one approach to additive fabrication, known as selective laser sintering, or “SLS”, a laser beam is used to selectively heat and fuse powder particles together to form a three-dimensional object. One illustrative description of selective laser sintering may be found in U.S. Pat. No. 4,863,538, incorporated herein in its entirety by reference. The powder used in SLS can be a variety of materials, including plastics, metals, ceramics, etc. SLS has been used in a variety of industries, such as automotive, aerospace, and medical, due to its ability to create intricate and complex shapes with a high degree of accuracy and precision.

### SUMMARY OF THE DISCLOSURE

Methods and systems for creating a 3D object using a powder-based additive fabrication technology, such as selective laser sintering (SLS), or by using stereolithography (SLA), are provided.

According to some aspects, the method and system involve retaining a first layer of powder of uniform thickness on a build platform, scanning a laser beam along a predetermined path to consolidate portions of the first layer of powder to form a cross-section of the 3D object, and depositing a second layer of powder of uniform thickness on top of the first layer prior to completing the scanning process. The powder deposition device is moved from one end of the build platform to the other, depositing the second layer on both the loose powder and the previously consolidated powder.

According to some aspects, the method and system involve moving a powder deposition device from one end of the build platform to the other, depositing a layer of powder as it moves across the platform. Before the powder deposition device reaches the end of the platform, a laser beam is started to scan the deposited layer of powder, with the laser beam path corresponding to a cross-section of the 3D object to be produced.

According to some aspects, the method and system involve displaying different patterns corresponding to cross-sections of the 3D object on an electrophoretic display (EPD) panel, retaining light polymerizable resin in a vessel, directing actinic energy from a light source through the EPD panel and towards the light polymerizable resin retained in the vessel. And moving a build platform vertically with respect to the vessel, wherein the actinic energy solidifies a layer of the light polymerizable resin on the build platform or on a previously formed layer of the light polymerizable resin on the build platform corresponding to the displayed pattern on the EPD panel.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF THE FIGURES

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 depicts an illustrative selective laser sintering device, according to some embodiments;

FIGS. 2A-2D depict an illustrative process of a powder recoating and lasing cycle on a conventional SLS additive fabrication device, according to some embodiments;

FIGS. 3A-3D depict an illustrative process of an improved powder recoating and lasing cycle on an SLS additive fabrication device, according to some embodiments;

FIG. 4 is a flowchart of a method of producing a 3D-dimensional object with improved lasing and powder deposition techniques, according to some embodiments;

FIGS. 5A-5C illustrate an example of a stereolithography (SLA) additive fabrication device with an electrophoretic display (EPD) panel, according to some embodiments;

FIGS. 6A-6B illustrate examples of EPD systems, according to some embodiments;

FIGS. 7A-7B illustrate an example of microsphere migration between different states of a one-pigment type EPD panel, according to some embodiments; and

FIG. 8 illustrates an example of a computing system environment on which aspects of the invention may be implemented.

### DETAILED DESCRIPTION

As described above, one approach to additive fabrication is Selective Laser Sintering (SLS), a laser beam or other directed energy source is used to selectively heat and fuse (or “consolidate”) powder particles together to form a three-dimensional object. One of the drawbacks of SLS is its slow speed, which limits its usefulness in certain applications. The speed limitations result from there being distinct production phases during fabrication that have conventionally been performed sequentially. These phases include heating of a build platform over which powder is deposited, powder deposition, powder recoating, directing energy onto the powder, build platform cooling, etc.

The present disclosure described systems and methods of selective laser sintering that produce three-dimensional objects with increased speed and efficiency by providing techniques for depositing powder over one part of the build platform while simultaneously consolidating powder over a different part of the build platform. In at least some cases, these techniques may be effectively utilized in any powder-based additive fabrication technology, and are not necessarily limited to use in SLS devices.

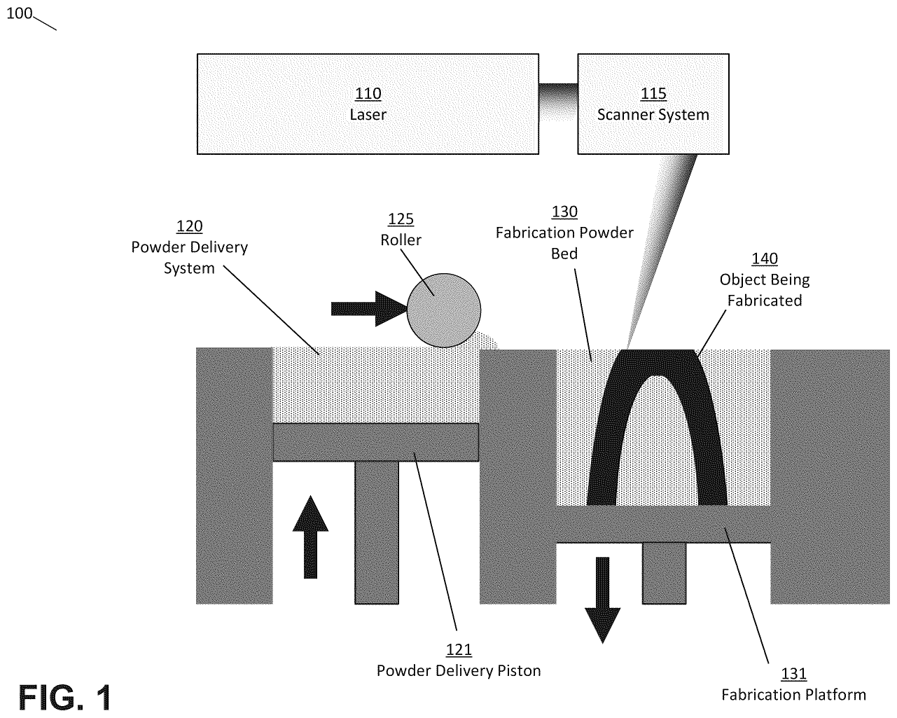

FIG. 1 depicts an illustrative selective laser sintering device, according to some embodiments. An illustrative system embodying certain aspects of the present application is depicted in FIG. 1. An illustrative selective laser sintering (SLS) additive fabrication device 100 comprises a laser 110 paired with a computer-controlled scanner system 115 disposed to operatively aim the laser 110 at the fabrication bed 130 and move over the area corresponding to a given cross-sectional area of a computer-aided design (CAD) model representing a desired part. Suitable scanning systems may include one or more mechanical gantries, linear scanning devices using polygonal mirrors, and/or galvanometer-based scanning devices.

In the example of FIG. 1, the material in the fabrication bed 130 is selectively heated by the laser in a manner that causes the powder material particles to fuse (sometimes also referred to as “sintering” or “consolidating”) such that a new layer of the object 140 is formed. According to some embodiments, suitable powdered materials may include any of the various forms of powdered nylon. Once a layer has been successfully formed, the fabrication platform 131 may be lowered a predetermined distance by a motion system (not pictured in FIG. 1). Once the fabrication platform 131 has been lowered, the material deposition mechanism 125 may be moved across a powder delivery system 120 and onto the fabrication bed 130, spreading a fresh layer of material across the fabrication bed 130 to be consolidated as described above. Mechanisms configured to apply a consistent layer of material onto the fabrication bed may include the use of wipers, rollers, blades, and/or other leveling mechanisms for moving material from a source of fresh material to a target location. Additional powder may be supplied from the powder delivery system 120 by moving the powder delivery piston 121 upwards.

Since material in the powder bed 130 is typically only consolidated in certain locations by the laser, some material will generally remain within the bed in an unconsolidated state. This unconsolidated material is commonly known in the art as the part cake. In some embodiments, the part cake may be used to physically support features such as overhangs and thin walls during the formation process, allowing for SLS systems to avoid the use of temporary mechanical support structures, such as may be used in other additive manufacturing techniques such as stereolithography. In addition, this may further allow parts with more complicated geometries, such as moveable joints or other isolated features, to be printed with interlocking but unconnected components.

The above-described process of producing a fresh layer of powder and consolidating material using the laser repeats to form an object layer-by-layer until the entire object has been fabricated. Once the object has been fully formed, the object and the part cake may be cooled at a controlled rate to limit issues that may arise with fast cooling, such as warping or other distortion due to variable rate cooling. The object and part cake may be cooled while within the selective laser sintering apparatus, or removed from the apparatus after fabrication to continue cooling. Once fully cooled, the object can be separated from the part cake by a variety of methods. The unused material in the part cake may optionally be recycled for use in subsequent prints.

In the example of FIG. 1, powder in the uppermost layer of the powder bed 130 is maintained at an elevated temperature, low enough to minimize thermal degradation, but high enough to require minimal additional energy exposure to trigger consolidation. Energy from the laser 110 is then applied to selected areas to cause consolidation. As discussed above, however, numerous problems can occur due to temperature differentials produced during this process. While some objects can be oriented to reduce or eliminate these issues, for most objects this is not feasible.

While the illustrative SLS device of FIG. 1 includes a laser as a source of directed energy, it will be appreciated that other SLS devices may rely on other sources of energy to cause consolidation of material. For instance, some SLS devices may utilize a two-dimensional array of independent energy sources, such as infra-red LEDs, and turn on selected ones of the LEDs to direct energy to selected regions of a powder bed. Other SLS devices may heat a portion of the powder bed while applying additional energy to selected regions of the powder bed and thereby cause consolidation. The subsequent discussion of thermal support techniques applies to any SLS device, including the example of FIG. 1 and alternatives mentioned here as the thermal support techniques do not depend on any particular method of delivering energy to a source material to cause consolidation of the material. This statement applies to methods of delivering energy to some or all of the surface of the powder bed to heat but not consolidate the powder, in addition to methods of delivering energy to particular locations on the powder bed to consolidate powder at those locations.

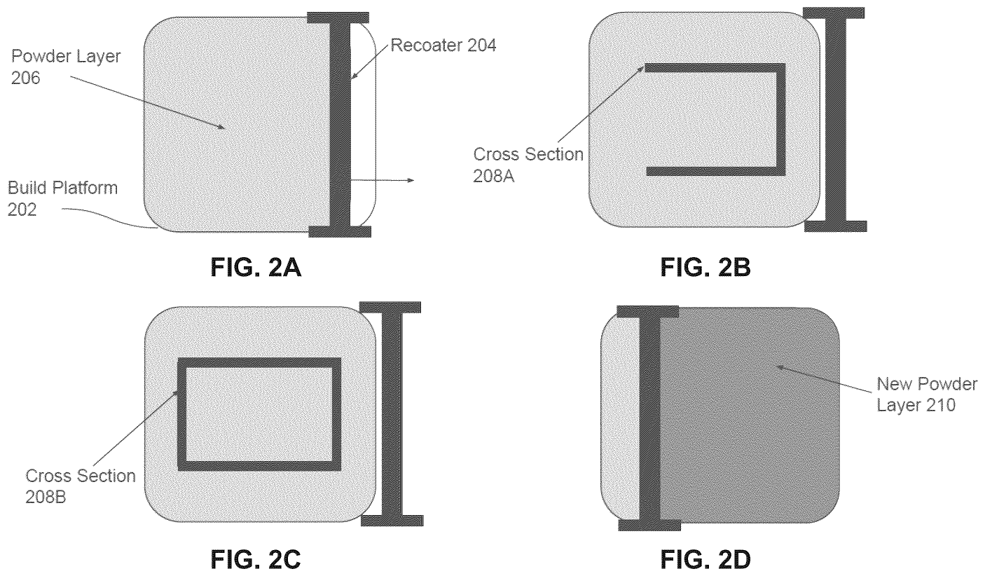

FIGS. 2A-2D depict an illustrative process of a powder recoating and lasing cycle on a conventional SLS additive fabrication device, according to some embodiments. Hereinafter, the act of consolidating powder using a source of directed energy may be referred to as being performed using a laser, and/or may be described as a step of “lasing,” although it will be appreciated that such a process does not require the use of a laser and may use any suitable source of directed energy, and the use of a laser is provided as an illustrative example for purposes of explanation. In each of FIGS. 2A-2D, the upper surface of a powder bed in an SLS device is shown as viewed from above.

As shown in FIG. 2A, a recoater 204 performs an initial step of a conventional SLS process for each layer of powder. The recoater 204 coats the build platform 202 with a fresh layer of powder 206 by moving over the build platform and depositing powder as the recoater 204 moves from left to right. The layer of powder 206 is distributed evenly across the build platform 202 to produce a powder layer with a uniform thickness.

In some embodiments, the build chamber is preheated to a predefined temperature. This predefined temperature facilitates the proper flow and adhesion of the layer of powder 206 during recoating, enhancing the subsequent laser sintering step.

As shown in FIG. 2B, a laser is operated to selectively heat specific portions of the layer of powder 206 corresponding to a cross-section of an object being fabricated. In some embodiments, operating the laser to produce selective heating comprises operating one or more mirror galvanometers optically coupled to the laser output. Irrespective of how the laser light is directed onto the powder, the light is arranged to follow a predefined path corresponding to a cross-section 208A of the 3D model to be printed.

To ensure proper consolidation (also referred to as “fusion”) of the powder material, in some embodiments, the laser is set to heat the powder to a temperature just below its melting point. This controlled heating causes the powder particles to fuse together along the path where the laser beam intersects the powder, forming a solidified layer. This fusion process enables the creation of intricate and precise structures based on the desired 3D model. During the conventional laser sintering process, the powder recoater 204 remains stationary and is positioned outside the operating area of the build platform 202.

As shown in FIG. 2C, subsequently the laser completes fusing the powder layer 206, leaving fused powder along the laser's path that corresponds to a complete cross-section 208 of the 3D object. As shown in FIG. 2D, in response to the laser finishing fusing the powder layer 206, the powder recoater 204 then moves across the build platform 202 (e.g., from right to left) to deposit a new powder layer 210. In some examples, the recoater 204 is uni-directional, meaning it can only deposit powder in one direction. As a result, the recoater 204 may be controlled to first move to the other end of the build platform (e.g., back to the left) before moving to the right to deposit a new layer of powder. In some embodiments, the recoater 204 waits for a predefined time period after the laser finishes fusing the powder to allow the powder sufficient time for cooling. The new powder layer 210 is ready to be fused again by the laser for the next cross-section of the 3D model to be printed. It is important to note that in this conventional lasing-recoating cycle, the powder recoating and lasing function phases are distinct and do not overlap.

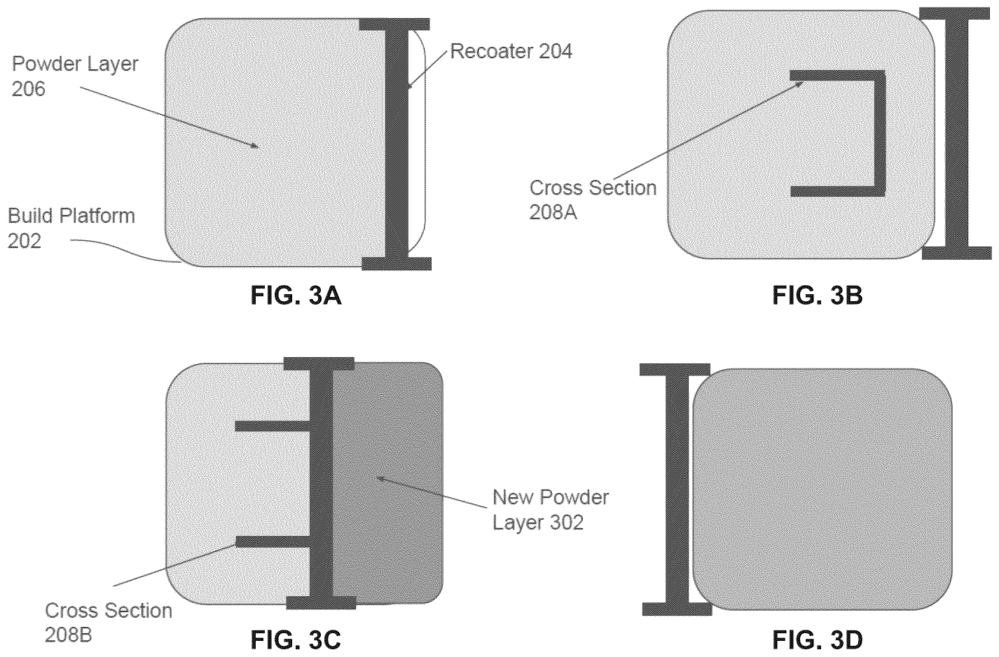

FIGS. 3A-3D depict an illustrative process of an improved powder recoating and lasing cycle on an SLS additive fabrication device, according to some embodiments. In each of FIGS. 3A-3D, the upper surface of a powder bed in an SLS device is shown as viewed from above.

FIGS. 3A-3B depict a process that is similar to that of FIGS. 2A-2B, where the recoater 204 moves from left to right across the build platform 202, and deposits a uniform powder layer 206. The recoater 204 is then positioned outside the operating area of the build platform 202. The laser of the SLS additive fabrication device starts to fuse portions of the powder layer 206 to form cross section 208A of the 3D object.

In contrast to the process shown in FIGS. 2C-2D, however, as shown in FIG. 3C the powder recoater 204 starts to move across (e.g., from right to left) the build platform 202 and deposits a new powder layer 302 while the lasing is still in process. For example, a computing device may determine that moving the powder recoater 204 early would not interfere with the lasing process as the remaining laser path is sufficiently far away from the starting end of the recoater 204. The computing device in question may be part of the SLS additive fabrication device shown in FIGS. 3A-3D (e.g., an onboard processor) or may be a computing device that generates instructions for the SLS additive fabrication device to execute to perform a sequence of operations to fabricate the object. In the latter case, the computing device (e.g., a desktop computer) may provide a user interface for arranging and orienting objects for fabrication, and may, when generating instructions that fabricate the objects when executed by an additive fabrication device, determine that the powder recoater 204 may be moved during lasing for one or more layers of the fabrication process, and ensure the generated instructions operate the recoated and laser in this manner when executed.

As the laser fuses powder by moving generally from right to left, the recoater 204 also starts moving from right to left, but always maintains a distance away from the laser spot. As a result, in the process depicted in FIG. 3C, the lasing phase overlaps the recoating phase, saving production time.

The delay time between the lasing phase and the recoating phase (e.g., the time between the laser finishes lasing and the recoater 204 finishes depositing the new layer of powder) is desired to be as small as possible to reach maximal time-saving. In practice, this delay time is limited by both time and geometric factors such as the recoating time, lasing time, lasing path geometry, and build platform size, etc.

In some embodiments, the computing device (examples of which are described above) may first set a recoating time (or recoating speed) of the powder recoater 204 (e.g., time it takes for the powder recoater to move from one end to the other). The recoater 204 can only start moving if the remaining lasing time is smaller than the recoating time.

In some embodiments, the computing device (examples of which are described above) may generate a path for the optical system to follow when scanning the powder that, at least in part, scans from the side of the powder bed where the recoater is located towards the other side of the powder bed. Since completing scanning near the recoater may in general allow the recoater to being moving sooner, it may be beneficial to configure the additive fabrication device to favor scanning that side of the powder bed before scanning the other side, where feasible. It will be appreciated that some scanning paths may initially direct light around the outline of regions of powder to be consolidated then fill in the interior of those regions (“infill”). In such approaches, the outlines may be performed in any suitable order, but the infill paths may be configured to be performed from the recoater side of the powder bed to the other side to allow the recoater to begin moving sooner.

In some embodiments, the computing device (examples of which are described above) performs a position analysis of the laser beam and the recoater 204 to ensure that the position of the recoater 204 will not interfere with the active laser beam when it begins to move. The time at which the recoater may begin to move will, in general, depend on when the various regions of the layer are consolidated by the laser.

FIG. 3D shows that the recoater has finished depositing new powder layer 302 as the lasing of the previous powder layer 206 completes. In another example, the laser path may be recalculated so it moves in a direction that aligns with the movement of the recoater 204.

Although FIGS. 3A-3D show that the recoating phase occurs after the lasing phase, in some embodiments, the time saving may be achieved by starting the lasing phase before the recoating phase finishes.

In the conventional approach shown in FIGS. 2A-2D, the recoater is typically operated after lowering the build platform on which the powder bed is arranged. That is, the conventional sequence of operations is to operate the laser on a first layer of powder, then lower then powder bed, then operate the recoater to deposit a second layer of powder on top of the first layer of powder, then operate the laser on the second layer of powder, etc. This process results in the powder bed being at one vertical position when the laser is operated, whereas the recoater deposits powder at a slightly lower vertical position (different by the height of one layer of powder).

In contrast, in the approach shown in FIGS. 3A-3D, the recoater is operated during lasing, and therefore the new powder is deposited before the build platform is lowered. Consequently, in the approach shown in FIGS. 3A-3D a second layer of powder is deposited over the first layer of powder (at least partially during lasing), and then the build platform is lowered to position the second layer of powder for subsequent lasing. This represents an additional difference in the sequence of operations, as the build platform is lowered subsequent to recoating in the approach of FIGS. 3A-3D in cases when the recoating begins during lasing, whereas in the conventional approach the build platform is always lowered prior to recoating.

In some embodiments, the recoater may be configured to deposit powder at a consistent height in the approach of FIGS. 3A-3D, even in cases where recoating does not start before lasing has completed. In this case, recoating is always performed prior to lowering the build platform. Alternatively, a recoater may be configured to deposit powder at one height when recoating begins during lasing, and to deposit powder at a different, lower, height above the build platform when recoating occurs after lasing is completed.

In some embodiments, the recoater mechanism is equipped with precision actuators that adjust the blade height in real time, ensuring consistent layer thickness across the entire build platform. This control is further enhanced by a feedback loop from the high-resolution cameras, which monitor the spread powder layer and make micro-adjustments to the recoater as needed.

In some embodiments, the SLS device incorporates an advanced sensor array to manage the overlap of recoating and lasing. The sensors, which may include optical encoders, infrared sensors, and position detection cameras, are positioned strategically around the build chamber. These sensors continuously monitor the position and progress of both the recoater, which may be equipped with an encoder to precisely track its speed and position, and the laser, whose path and focal point may be monitored by the position detection cameras. For example, an infrared sensor could be employed to detect the temperature profile of the powder bed and the freshly sintered layer, ensuring that the recoater does not disturb the powder in areas that have not yet sufficiently cooled. This real-time data feeds into a control algorithm, which dynamically adjusts the recoater's speed and the laser's path to prevent any interference. For instance, if the laser is actively sintering the rear portion of the build platform, the recoater may begin to distribute a new layer of powder at the front portion, moving at a calculated speed that allows the laser to complete its current path without encountering unsintered powder. The control algorithm can also adjust the laser's scan speed and power output based on feedback from the sensors, ensuring seamless operation without compromising the integrity of the sintered parts. Through this sophisticated coordination, the system ensures that the recoater and laser operate in harmony, allowing for an efficient and uninterrupted printing process.

In some embodiments, the improved process is designed to be adaptable to various powder materials, including polymers, metals, and ceramics. For example, the system software includes a database of material properties, which it uses to automatically adjust the recoating speed, laser power, and scan speed based on the selected material. This ensures optimal sintering conditions for a wide range of materials, enhancing the versatility of the SLS machine.

Further, the additive fabrication device may comprise a high-resolution camera and laser scanning system to monitor the quality of each layer in real time. This setup allows for the immediate detection of any defects or irregularities, enabling the machine to automatically adjust the process parameters or pause the print for manual intervention if necessary. This proactive approach to quality control ensures that the final product meets the desired specifications.

In some embodiments, the recoater mechanism of the improved SLS device is engineered with an innovative design that enhances its adaptability and efficiency. The recoater is equipped with a blade whose pressure against the powder bed can be precisely controlled through adjustable tension springs or pneumatic actuators. These pressure settings are programmable and can be automatically adjusted based on the type of powder material being used, its flow characteristics, or the specific layer being spread. For example, a more fluid powder may require less pressure to achieve an even layer, whereas a powder with a higher viscosity may necessitate increased pressure.

Furthermore, the recoater incorporates a dynamic feedback system, which includes a series of sensors—such as acoustic sensors that monitor the sound profile of powder flow or capacitive sensors that measure the proximity of the powder to the blade. These sensors provide real-time data on the powder's behavior during the recoating process. The feedback system utilizes this data to actively adjust the blade angle, which can be altered by precision servo motors connected to the blade assembly. This real-time adjustment ensures the blade interacts with the powder in a manner that promotes a uniform spread without exerting excessive force on the partially sintered layers beneath.

For instance, if the sensors detect a region where the powder is not flowing smoothly or is clumping, the system can immediately respond by minutely tilting the blade to enhance the spread without causing disruptions to the underlying sintered material. This capability is particularly beneficial when operating in conjunction with the overlapping lasing process, as it allows the recoater to adapt to the dynamic conditions of the build platform ensuring that new powder is applied consistently and that the integrity of the build is maintained at all times.

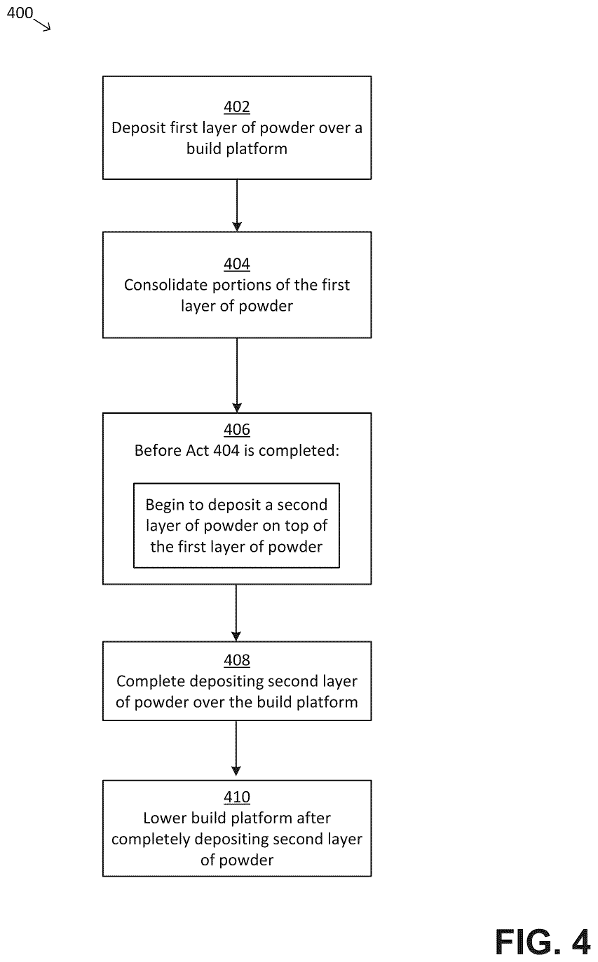

FIG. 4 depicts an improved process of producing a 3D-dimensional object using an powder-based additive fabrication method, according to some embodiments. In method 400, act 402 comprises operating a powder deposition device to deposit a first layer of loose, unconsolidated powder over the build platform (e.g., directly on top of the build platform, or otherwise over the build platform; in this manner, all layers of powder are deposited over the build platform) of the additive fabrication device (act 402). The layer of powder deposited is of a uniform, predefined thickness.

In act 404, portions of the first layer of powder deposited in act 402 are consolidated by scanning a laser beam over the first layer of powder, which fuses portions of the powder along the laser beam's path as described above. The path of the laser beam corresponds to a cross-section of the 3D object to be produced, or to a structure that will support or protect the object (e.g., structural support or thermal support). The laser beam is used to fuse the powder along its path, resulting in the creation of a solid cross-section of the 3D object.

Conventionally, only after the laser finishes fusing the first layer of powder, a powder deposition device starts to move across the build platform to deposit a new layer of powder. However, this waiting causes delays in the print production process, especially when the build platform is large or the geometry for the laser beam path is complex.

As an improvement to the conventional process, in act 406, prior to completing the act of consolidating portions of the first layer of powder, the powder deposition device is operated to deposit additional powder on top of the first layer of powder while the laser beam is being scanned over the first layer of powder. This additional powder represents an initial portion of a second layer of powder, and in general only some of the second layer of powder will be deposited when the laser beam completes scanning of the first layer of powder. Operating the powder delivery device in act 406 may comprise moving the powder deposition device from a first end of the powder bed toward a second end of the powder bed. As with the first layer of powder, the second layer of powder may be of a uniform, predefined thickness.

Subsequently, the powder deposition device is operated to complete depositing the second layer of powder (act 408). Subsequent to act 408 being completed, the build platform is lowered in preparation for portions of the second layer of powder to be consolidated (act 410).

This process is repeated multiple times, with each subsequent layer building upon the previous one, until the entire 3D object (or objects) are formed.

In some embodiments, a computing device (examples of which are described above) employs a predictive modeling algorithm that calculates the optimal recoating and lasing speeds for each layer, based on the geometry of the part being printed and the specific material properties. This model takes into account real-time feedback from the sensors to dynamically adjust the speeds, maximizing efficiency while ensuring quality.

In some embodiments, an SLS device may be outfitted with an advanced thermal management system that is critical for maintaining a uniform temperature distribution within the build chamber, which is essential for the quality and consistency of the printed parts. This system comprises a network of infrared (IR) sensors distributed throughout the chamber to continuously monitor the temperature profile of the entire build area. These sensors can detect minute variations in temperature across the powder bed and the sintered sections.

In conjunction with the IR sensors, the system includes an array of adjustable heating elements, which may be composed of resistive heaters or radiant heat sources, positioned strategically to provide targeted heating. The heating elements are controlled by a sophisticated algorithm that processes the real-time data from the IR sensors. For example, if the sensors detect a zone that is cooling more rapidly than desired, the algorithm can instantaneously increase the output of the nearest heating elements to compensate for the heat loss.

Additionally, the system can preemptively adjust the heating elements' output in anticipation of the recoater's movement or the laser's heat input. For instance, as the recoater moves to spread a new layer of powder, the system may reduce the heating intensity to accommodate the insulating effect of the fresh powder. Conversely, when the laser sintering process is active, the system may dynamically reduce the heat in the immediate vicinity of the laser's path to mitigate the risk of overheating.

This proactive and responsive thermal management system is designed to maintain a stable processing environment, ensuring that both the unsintered powder and the newly sintered layers are kept within an optimal temperature range. By doing so, the system aids in reducing thermal-induced stresses and distortions, contributing to the production of parts with superior mechanical properties and dimensional accuracy.

Therefore, this improved process compacts the lasing phase with the powder deposition phase, saving considerable time for print production. In addition, reduced print time in turn lowers the energy consumption of the SLS machine. In some embodiments, the powder deposition device is configured to move and deposit powder in both directions. As a result, more time saving is achieved as the powder deposition device starts to move and deposit powder, either from the first end to the second end, or from the second end to the first end, before the lasing finishes.

The wait time between the laser finishes fusing and the powder deposition device starts to move depends on both time and position factors, such as: (1) the moving speed of the powder deposition device (which may be further dependent on the thickness of the layer of the powder); (2) the geometry of the laser path (which determines how fast the laser finishes fusing the loose powder); and/or (3) the size of the cross-section of the object to be printed (affecting total lasing time). As a result, the time at which the powder deposition device can safely begin to be operated (or the time delay between the lasing and moving the powder deposition device) may be calculated for each layer to be deposited during fabrication.

In some embodiments, the powder deposition may be initiated first and the lasing occurs before the powder deposition finishes.

In another approach to additive fabrication, known as stereolithography or inverted stereolithography (SLA), solid objects are created by successively forming thin layers of a curable polymer resin, typically first onto a build surface and then one on top of another. Exposure to actinic radiation cures a thin layer of liquid resin, which causes it to harden and adhere to previously cured layers and/or to a print substrate (i.e., film layer). As such, the adhesion between the previously formed layer of liquid resin and the print substrate must be separated before forming the next thin layer of liquid resin.

Liquid crystal display (LCD) panels have been used to control the solidification of resin in SLA. The LCD panel acts as a mask to selectively expose and cure specific areas of the resin corresponding to a cross-section of the object to be 3D printed. This process is performed layer-by-layer until one or more objects have been fabricated.

However, LCD panels have several limitations. One significant disadvantage of using LCD panels is their relatively short lifespan. LCD panels are susceptible to degradation over time due to repeated exposure to visible UV light, heat, moisture, and mechanical stress. This can result in decreased performance and reliability, and can make it necessary to replace the LCD panel after only a few hundred hours of use. Another disadvantage of using LCD panels is that they include polarizers that significantly attenuate light transmitted, therefore requiring more powerful light sources and generating a lot of waste heat. Additionally, LCD panels can be subject to image retention and ghosting, which can negatively impact the quality of the final 3D-printed product.

Therefore, a new technology for controlling the solidification of resin in the build area during an SLA process is highly desirable.

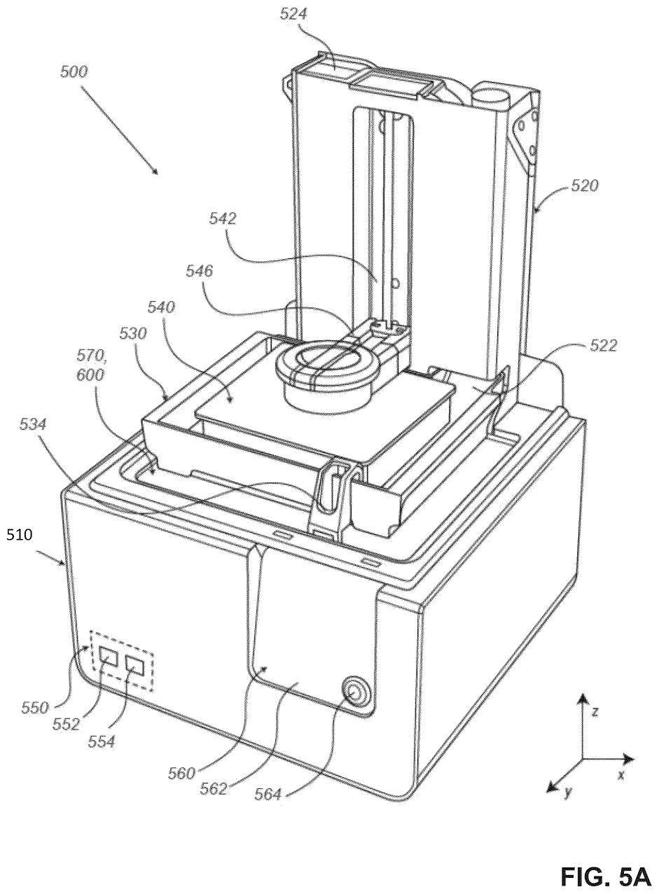

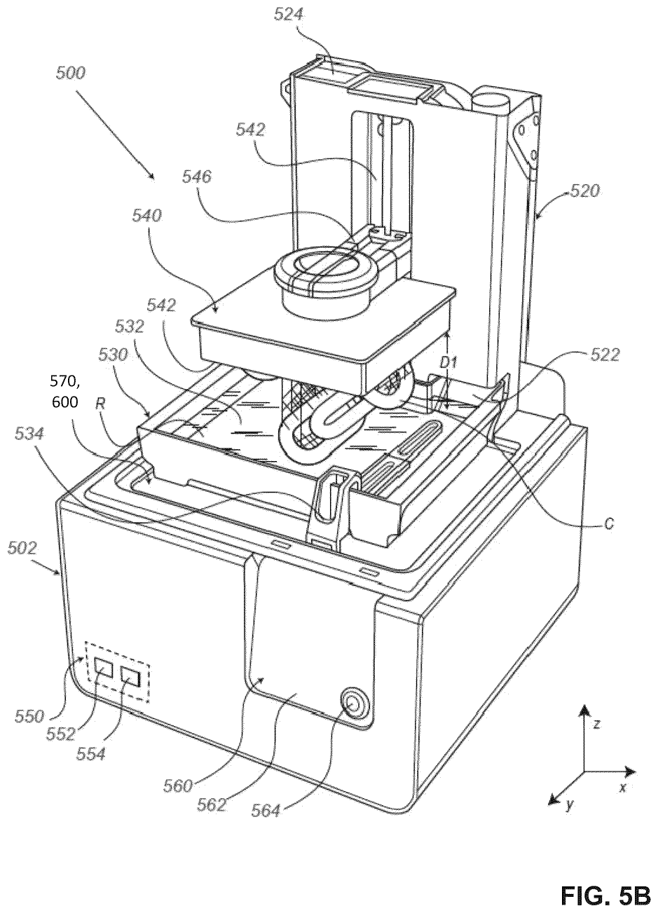

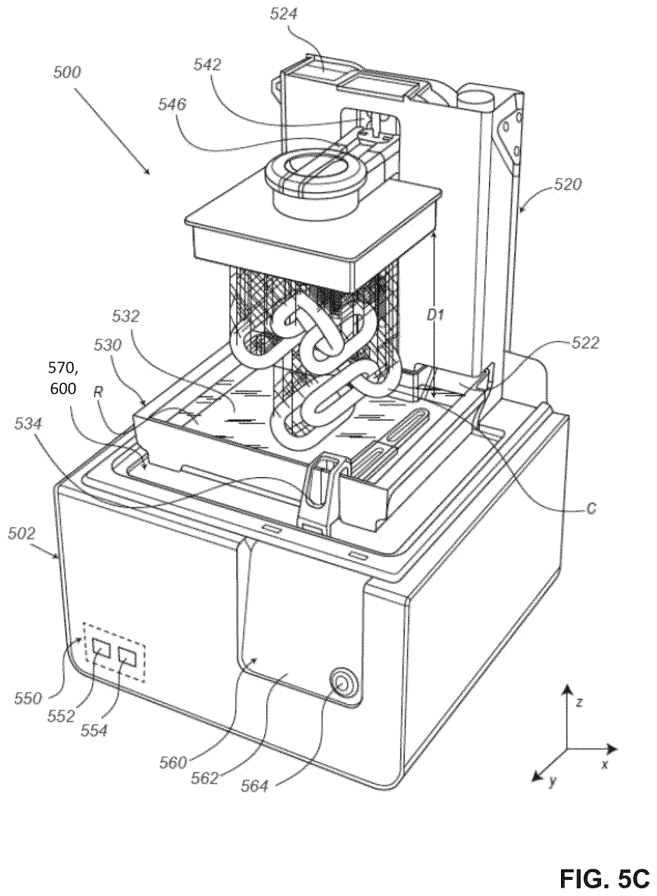

FIGS. 5A-5C illustrate an example of a stereolithography (SLA) additive fabrication device 500 (also referred to herein as printer 500) with an electrophoretic display (EPD) panel. Traditional SLA devices are equipped with a liquid crystal display (LCD) panel or a digital light processing device. The integration of an electrophoretic display (EPD) panel in the SLA 3D printer, as will be explained below, presents several advantages over traditional SLA devices. Unlike LCDs or DMDs, EPD panels offer exceptional energy efficiency, consuming power only during state transitions, which contributes to reduced overall power consumption in the SLA printing process. Additionally, EPD panels exhibit superior contrast ratios and wide viewing angles, resulting in improved precision and clarity in mask pattern projection. Further, the EPD integration can extend the lifespan of the additive fabrication device. LCD panels are susceptible to degradation over time when exposed to prolonged periods of light. The organic compounds and liquid crystals within LCDs can experience photodegradation, leading to a decline in performance and color accuracy. In contrast, EPD panels are inherently more resilient to light exposure due to their use of electrophoretic particles suspended in a clear fluid. This characteristic renders EPD panels highly durable, ensuring prolonged functionality and maintaining consistent image quality over an extended operational lifespan.

FIG. 5A shows the additive fabrication device 500 with a base 510 and a dispensing system 520 coupled to the base 510. The base 510 supports a fluid basin 530 configured to receive a photopolymer resin from the dispensing system 520. The printer 500 further includes a build platform 540 positioned above the fluid basin 530 and operable to traverse a vertical axis (e.g., z-axis) between an initial position (FIG. 5A) adjacent to a bottom surface 532 of the fluid basin 530 and a finished position (FIG. 5C) spaced apart from the bottom surface 532 of the fluid basin 530.

The base 510 of the printer 500 may house various mechanical, optical, electrical, and electronic components operable to fabricate objects using the device. In the illustrated example, the base 510 includes a computing system 550 including data processing hardware 552 and memory hardware 554. The data processing hardware 552 is configured to execute instructions stored in the memory hardware 554 to perform computing tasks related to activities (e.g., movement and/or printing-based activities) for the printer 500. Generally speaking, the computing system 550 refers to one or more locations of data processing hardware 552 and/or memory hardware 554. For example, the computing system 550 may be located locally on the printer 500 or as part of a remote system (e.g., a remote computer/server or a cloud-based environment).

The base 510 may further include a control panel 560 connected to the computing system 550. The control panel 560 includes a display 562 configured to display operational information associated with the printer 500 and may further include an input device 564, such as a keypad or selection button, for receiving commands from a user. In some examples, the display is a touch-sensitive display providing a graphical user interface configured to receive the user commands from the user in addition to, or in lieu of, the input device 564.

The base 510 houses a curing system 570 configured to transmit actinic radiation into the fluid basin 530 to incrementally cure layers of the photopolymer resin contained within the fluid basin 530. The curing system 570 may include a projector or other radiation source configured to emit light at a wavelength suitable to cure the photopolymer resin within the basin. Thus, different light sources may be selected depending on the desired photopolymer resin to be used for fabricating component C. In the present disclosure, the curing system 570 includes an electrophoretic display (EPD) panel 600 for transmitting light from the projector/radiation source to cure the photopolymer resin within the fluid basin 530.

The EPD panel 600, also known as an e-ink panel, operates based on the movement of charged pigment particles suspended in a clear fluid under the influence of an electric field. The EPD panel 600 in the context of the SLA 3D printer serves as a dynamic mask, which selectively allows or blocks the passage of actinic radiation, thus controlling the pattern of exposure on the surface of the photopolymer resin.

In some embodiments, the EPD panel 500 comprises a matrix of microcapsules, each containing positively and negatively charged particles that are colored differently typically black and white. When an electric field is applied across the microcapsule, the charged particles move to the top or bottom of the capsule, depending on their charge and the polarity of the field. This movement changes the apparent color of the microcapsule, effectively creating a pixel on the display. A feedback system incorporating sensors could be integrated to monitor the EPD panel's performance. This system would detect any inconsistencies in particle movement and adjust the electric field accordingly. Algorithms could be developed to predict and compensate for these non-uniformities, ensuring consistent mask patterns.

In the additive fabrication device 500, the EPD panel 500 is integrated into the curing system 570 and is positioned between the light source (e.g., LED) and the fluid basin 530. The computing system 550 controls the electric field applied to the EPD panel 500, thus manipulating the position of the charged particles within each microcapsule to form the desired pattern for each layer of the 3D object being printed. The pattern corresponds to cross-sections of the component C to be fabricated. A system of lenses or mirrors could be incorporated to work in tandem with the EPD panel. This system could focus or diffuse the light selectively, allowing for more complex exposure patterns. This could be particularly useful for creating gradient exposures or for compensating for any optical aberrations caused by the EPD panel.

To facilitate the use of the EPD panel 500 in the curing system 570, the panel is designed to be transparent when the charged particles are in a state that allows the passage of light. When the additive fabrication device 500 is operational, the computing system 550 activates the EPD panel 500 to display a pattern that correlates to the layer being cured. Actinic radiation from the light source passes through the transparent areas of the EPD panel 500, curing the resin in the corresponding regions. The opaque areas, where the charged particles block the light, prevent curing, allowing the printer to build up component C layer by layer with high precision. A calibration protocol could be established where the EPD panel is subjected to a series of electrical field patterns to ensure accurate particle movement. This could be performed periodically or before critical print jobs to ensure the fidelity of the mask pattern over the lifespan of the device. The EPD panel could be designed as a modular component that easily slots into the curing system. This would allow users to replace or upgrade the panel without specialized tools or training. The modularity would also facilitate the cleaning or replacement of individual microcapsules or zones if they become defective.

The EPD panel 500 offers advantages over traditional LCD or DMD masking technologies, such as lower power consumption and potentially higher resolution, depending on the implementation. Additionally, the bistable nature of the electrophoretic technology means that the EPD panel 500 can maintain a pattern without a continuous power supply, only requiring energy when changing the pattern for the next layer. This characteristic can lead to energy savings and prolonged operational life for the panel.

As shown, the fluid basin 530 is disposed atop the base 510 adjacent to the curing system 570 and is configured to receive a supply of the resin R from the dispensing system 520. The dispensing system 520 may include an internal reservoir 524 providing an enclosed space for storing the resin until the resin is needed in the fluid basin 530. The dispensing system 520 further includes a dispensing nozzle 522 in communication with the fluid basin 530 to selectively supply the resin R from the internal reservoir 524 to the fluid basin 530.

The build platform 540 may be movable along a vertical track or rail 542 (oriented along the z-axis direction, as shown in FIGS. 5A-5C) such that base-facing build surface 544 of the build platform 540 is positionable at a target distance D1 along the z-axis from the bottom surface 532 of the fluid basin 530. The target distance D1 may be selected based on the desired thickness of a layer of solid material to be produced on the build surface 544 of the build platform 540 or onto a previously formed layer of the object being fabricated. In some implementations, the build platform 540 is removable from the printer 500. For instance, the build platform 540 may be attached to the rail 542 by an arm 546 (e.g., pressure fit or fastened onto) and may be selectively removed from the printer 500 so that a fabricated component C attached to the build surface 544 can be removed via the techniques described above.

In the example of FIGS. 5A-5C, the bottom surface 532 of basin 530 may be transparent to actinic radiation that is generated by the curing system 570 located within the base 510, such that liquid photopolymer resin located between the bottom surface 532 of the basin 530 and the build surface 544 of the build platform 540 or an object being fabricated thereon, may be exposed to the radiation. Upon exposure to such actinic radiation, the liquid photopolymer may undergo a chemical reaction, sometimes referred to as “curing,” that substantially solidifies and attaches the exposed resin to the build surface 544 of the build platform 540 or to a bottom surface of an object being fabricated thereon.

Following the curing of a layer of the fabrication material, the build platform 540 may incrementally advance upward along the rail 542 in order to reposition the build platform 540 for the formation of a new layer and/or to impose separation forces upon any bond with the bottom surface 532 of basin 530. In addition, the basin 530 is mounted onto the support base such that the printer 500 may move the basin 530 along a horizontal axis of motion (e.g., x-axis), the motion thereby advantageously introducing additional separation forces in at least some cases. A wiper 534 is additionally provided, capable of motion along the horizontal axis of motion and which may be removably or otherwise mounted onto the base 510 or the fluid basin 530.

With continued reference to FIGS. 5A-15C, the printer 500 is shown at different stages of the fabrication process. For example, in FIG. 5A, the printer is shown in an initial state prior to dispensing the resin R into the basin 530 from the reservoir 524 of the dispensing system 520. Upon receipt of fabrication instructions, the printer 500 positions the build surface 544 of the build platform 540 at an initial distance D1 from the bottom surface 532 of the basin 530 corresponding to a thickness of the first layer of resin R to be cured. The curing system 570 then emits an actinic radiation profile (i.e., an image) corresponding to the profile of the current layer of the component C to cure the current layer. Upon curing the current layer, the build platform 540 incrementally advances upward to the next build position. The distance of each advancement increment corresponds to the thickness of the next layer to be fabricated. The curing system 570 then projects the profile of the component layer corresponding to the new position. The new component layer is cured on the bottom surface of the previous component layer. The curing and advancing steps repeat until the build platform 540 reaches the final position (FIG. 5C) corresponding to the finished component C.

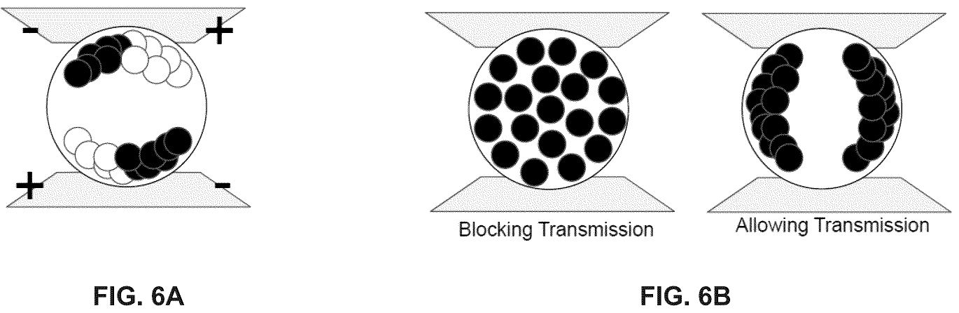

FIGS. 6A-6B illustrate examples of electrophoretic display systems, according to some embodiments. Electrophoretic displays (EPDs), also known as e-inks or electronic papers, are most commonly used for e-readers, digital signages, and other devices where stability and low power consumption are advantageous.

FIG. 6A shows a two-pigment system for an EPD panel. The two-pigment EPD systems are traditionally used in reflective displays, such as e-readers and electronic shelf labels.

The two-pigment systems can be used to display bi-stable grayscale images: oppositely charged white and black pigments are encapsulated in a polymer microsphere and placed between two transparent electrodes. Pigments will be attracted to, and migrate toward, an electrode maintaining the opposite charge. For example, to display a black image, the top electrode will attract black particles and repel white particles, and vice versa.

FIG. 6B shows a one-pigment system for an EPD panel. The one-pigment system can be used to make a transmissive display (e.g., similar to that of an LCD panel) that selectively blocks the transmission of light at pixels of the display. For example, the one-pigment system may be used in the EPD panel 600 as described in FIGS. 5A-5C. When an electrical field is applied, corresponding particles migrate to the sides of the capsule, therefore allowing light to transmit through the capsule.

In some embodiments, the particles may exist as a continuous phase of active material, or be contained within a secondary encapsulation such as microsphere. In some embodiments, particles may be made of UV or near-UV-blocking materials, such as metal oxides (ZnO, TiO2) or other macromolecular particles.

In some embodiments, the electrophoretic display (EPD) panel is configured with a pixel pitch ranging from 50 μm to 200 μm, enabling the production of high-resolution prints with precise edge definition. For example, the EPD panel may utilize a high-density thin-film transistor (TFT) array to accurately control the position and movement of charged particles, thereby achieving layer thicknesses and feature sizes that are on par with or superior to those produced by traditional LCD/DMD systems. To ensure uniform light distribution across the build area, which is critical for consistent resin curing, the panel may employ a uniform electrode pattern and particle distribution within the microcapsules to mitigate potential non-uniformity in light transmission, thereby maintaining the quality of each printed layer.

In some embodiments, an EPD panel has a contrast ratio, ranging from 5:1 to 500:1, and response time between 0.1 s-2 s, and a pixel pitch from 50 μm-200 μm.

In some embodiments, an EPD panel has different shapes. For example, an EPD panel can have a rectangular shape, a circular shape, a triangular shape, or other irregular shapes.

In some embodiments, an EPD panel is made on a rigid substrate. Alternatively, the EPD panel is made on a flexible substrate. For example, a flexible EPD panel may use polyimide substrates to create displays that can be bent and folded.

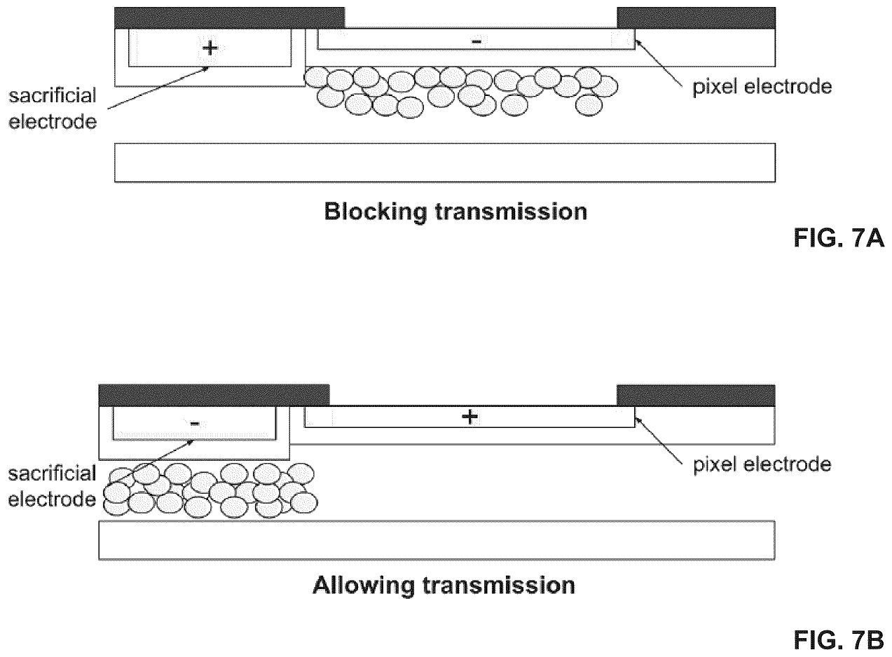

FIGS. 7A-7B illustrate an example of particle migration between different states of a one-pigment type EPD panel, according to some embodiments. FIGS. 7A-7B shows how one pixel can be turned on and off in an EPD panel implemented on an SLA 3d printer.

In an OFF state, the particles cover the pixel electrode, blocking light from reaching the resin. In the ON state, the particles migrate to the sacrificial electrode, clearing the pixel aperture for light transmission.

Replacing a traditional LCD with an EPD panel in an SLA device has several notable benefits. An EPD panel can have an optical efficiency an order of magnitude greater than an LCD panel, which reduces the input optical power and thermal system requirements. An EPD panel can be made to have a longer lifespan than an LCD, with materials that do not degrade with UV exposure. Further, EPD panels can be made with pigments of selected light-blocking properties, tailored to the resin material.

Below is an example process for producing an object using an SLA 3D printer with an EPD panel:

The first step involves displaying different patterns corresponding to cross-sections of the 3D object on an electrophoretic display (EPD) panel. The EPD panel is a device that uses electrical fields to display images or patterns. In this case, the EPD panel is used to display patterns corresponding to the cross-sections of the 3D object that is being fabricated.

The next step is retaining light polymerizable resin in a vessel. The light polymerizable resin is a type of material that can be solidified or cured by exposure to light. The resin is held in a vessel so that it can be directed toward the build platform in the next step.

The third step involves directing actinic energy from a light source through the EPD panel and towards the light polymerizable resin retained in the vessel. The light source provides the energy necessary to cure the resin and solidify it into a solid form. The energy is directed through the EPD panel and towards the resin, and the EPD panel acts as a mask, only allowing light to pass through the pattern corresponding to the cross-section of the 3D object.

The final step involves moving a build platform vertically with respect to the vessel. After each layer of the 3D object is solidified, the build platform is moved vertically relative to the vessel, allowing for the creation of a new layer of the object. The new layer is solidified by directing actinic energy through the EPD panel and towards the resin, solidifying it in the shape of the pattern displayed on the EPD panel. This process is repeated until the entire 3D object is created.

This method of producing 3D objects is efficient and accurate, as it allows for the creation of highly detailed objects layer by layer. The use of the EPD panel and light source to direct the actinic energy towards the resin ensures that each layer is solidified with precision, resulting in a high-quality 3D object. The patent claim protects this method as proprietary, allowing the inventor or owner of the patent to prevent others from using the method without their permission.

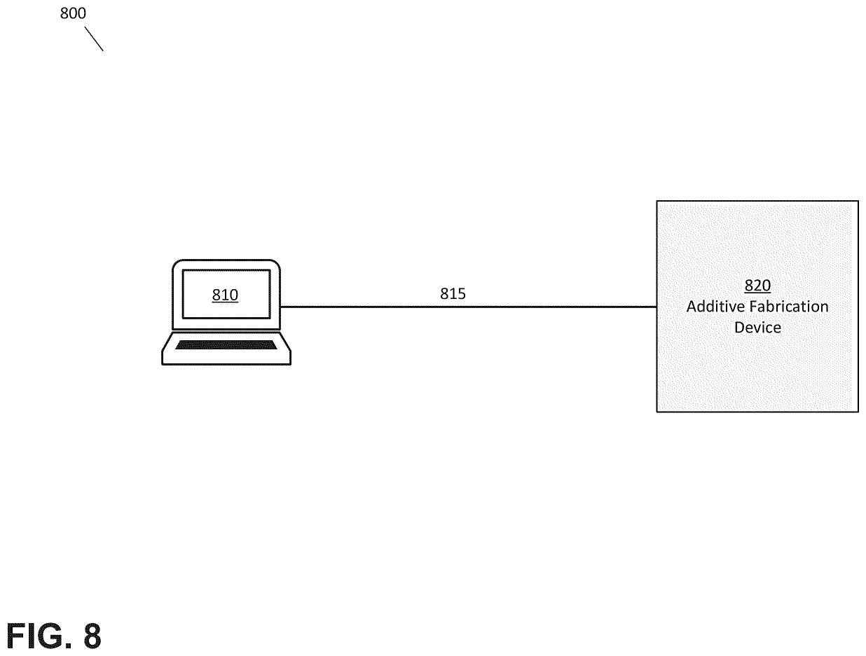

FIG. 8 is a block diagram of a system suitable for practicing aspects of the invention, according to some embodiments. System 800 illustrates a system suitable for generating instructions to perform additive fabrication by an additive fabrication device (including the SLS and SLA devices described herein) and subsequent operation of the additive fabrication device to fabricate an object. For instance, instructions to fabricate an object using an additive fabrication system may comprise instructions to operate a powder delivery device, build platform and optical system of an SLS system.

According to some embodiments, computer system 810 may execute software that generates two-dimensional layers that may each comprise sections of the object. Instructions may then be generated from this layer data to be provided to an additive fabrication device, such as additive fabrication device 820, that, when executed by the device, fabricates the layers and thereby fabricates the object. As described above, such instructions may be generated for an SLS device so that the SLS device operates a powder delivery device to begin depositing a new layer of powder while an optical system of the SLS device is being directed onto a previously deposited layer of powder beneath the new layer. Such instructions may be communicated via link 815, which may comprise any suitable wired and/or wireless communications connection. In some embodiments, a single housing holds the computing system 810 and additive fabrication device 820 such that the link 815 is an internal link connecting two modules within the housing of system 800.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further aspects may include:

Aspect 1. A method of producing a three-dimensional (3D) object on a selective laser sintering (SLS) device, comprising: retaining a first layer of powder on a build platform of the SLS device; scanning a laser beam to consolidate portions of the first layer of powder along the laser beam's path, wherein the laser beam's path corresponds to a cross-section of the 3D object to be produced; and prior to completing the scanning of the laser beam on the first layer of powder, moving a powder deposition device from a first end of the build platform towards a second end of the build platform, wherein the powder deposition device deposits a second layer of powder on top of the first layer of powder.

Aspect 2. The method of aspect 1, further comprising: in response to the powder deposition device completing depositing the second layer of powder on the build platform, scanning the laser beam to consolidate portions of the second layer of powder (that corresponds to a second cross-section of the object to be produced); and prior to completing the scanning of the laser beam on the second layer of powder, moving the powder deposition device from the second end of the build platform towards the first end of the build platform, wherein the powder deposition device deposits a third layer of powder on top of the second layer of powder.

Aspect 3. The method of aspect 1, further comprising: prior to moving the powder deposition device, confirming that moving the powder deposition device would not interfere with the lasing process.

Aspect 4. The method of aspect 1, further comprising: in response to completing the scanning of the laser beam on the first layer or second layer of powder, inspecting the first layer or second layer of powder for defects using a high-resolution camera system.

Aspect 5. The method of aspect 1, wherein the powder deposition device includes adjustable springs to control a pressure exerted by the powder deposition device against the first or second layer of powder.

Aspect 6. The method of aspect 1, wherein the powder deposition device includes sensors to monitor powder behavior during a recoating process.

Aspect 7. A selective laser sintering (SLS) device for producing a three-dimensional (3D) object, comprising: a build platform configured to retain a first layer of powder; a laser scanning system configured to scan a laser beam to consolidate portions of the first layer of powder along the laser beam's path, wherein the laser beam's path corresponds to a cross-section of the 3D object to be produced; and a powder deposition device configured to move from a first end of the build platform towards a second end of the build platform to deposit powder, wherein the powder deposition device is configured to initiate depositing a second layer of powder on top of the first layer of powder prior to the laser scanning system completing the scanning of the laser beam on the first layer of powder.

Aspect 8. A method of producing a three-dimensional object on a selective laser sintering (SLS) device, comprising: moving a powder deposition device from a first end of a build platform of the selective laser sintering device towards a second end of the build platform; while the powder deposition device is moving from a first end of a build platform of the selective laser sintering device towards a second end of the build platform, depositing a layer of powder on the build platform; and prior to the powder deposition device reaches the second end of the build platform (e.g., finishes depositing the layer of powder on the build platform), starting to scan a laser beam on the deposited layer of powder, wherein the laser beam path corresponds to a cross-section of the 3D object.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating an additive fabrication device to fabricate a three-dimensional object, the method comprising:
using at least one processor:
operating a powder deposition device to arrange a first layer of powder over a build platform of the additive fabrication device;
scanning a laser beam to consolidate portions of the first layer of powder along a path of the laser beam, wherein the laser beam's path corresponds to a cross-section of an object being fabricated; and
prior to completing the scanning of the laser beam on the first layer of powder, operating the powder deposition device to deposit powder on top of at least part of the first layer of powder.

2. The method of claim 1, wherein the powder deposited on top of at least part of the first layer of powder is a portion of a second layer of powder, and wherein the method further comprises continuing to operate the powder deposition device to completely deposit the second layer of powder over the first layer of powder.

3. The method of claim 2, further comprising, subsequent to completely depositing the second layer of powder, lowering the build platform to position the second layer of powder for scanning of the laser beam to consolidate portions of the second layer of powder.

4. The method of claim 2, further comprising, in response to the powder deposition device completing depositing the second layer of powder on the build platform, scanning the laser beam to consolidate portions of the second layer of powder.

5. The method of claim 4, further comprising, prior to completing the scanning of the laser beam on the second layer of powder, operating the powder deposition device to deposit powder over at least part of the second layer of powder.

6. The method of claim 1, further comprising:
prior to moving the powder deposition device, determining, by the at least one processor, that moving the powder deposition device over the first layer of powder would not interfere with the scanning of the laser beam on the first layer of powder.

7. The method of claim 1, further comprising:
in response to completing the scanning of the laser beam on the first layer of powder, determining, by the at least one processor, whether or not the first layer comprises any defects based on image data generated by a high-resolution camera.

8. The method of claim 1, wherein the powder deposition device includes adjustable springs to control a pressure exerted by the powder deposition device against the first layer of powder.

9. The method of claim 1, wherein the powder deposition device includes one or more sensors configured to monitor powder behavior during a recoating process.

10. An additive fabrication device for producing three-dimensional (3D) objects, the additive fabrication device comprising:
a build platform;
a powder bed arranged over the build platform;
a laser scanning system configured to scan a laser beam over the powder bed, and to thereby consolidate regions of powder along a path of the laser beam, wherein the path corresponds to a cross-section of a 3D object being fabricated; and
a powder deposition device configured to deposit powder over the powder bed, wherein the powder deposition device is configured to initiate depositing a second layer of powder on top of a first layer of powder prior to the laser scanning system completing scanning of the laser beam on the first layer of powder.

11. The additive fabrication device of claim 10, wherein the powder deposition device is configured to deposit a layer of powder in part by moving from a first end of the powder bed towards a second end of the powder bed.

12. The additive fabrication device of claim 10, wherein the powder deposition device includes adjustable springs to control a pressure exerted by the powder deposition device against the first layer of powder.

13. The additive fabrication device of claim 10, wherein the powder deposition device includes one or more sensors configured to monitor powder behavior during a recoating process.

14. A method of operating an additive fabrication device to fabricate a three-dimensional object, the method comprising:
moving a powder deposition device from a first end of a powder bed of the additive fabrication device towards a second end of the powder bed;
while the powder deposition device is moving from the first end of the powder bed towards the second end of the powder bed, depositing powder on the powder bed; and
prior to the powder deposition device reaching the second end of the powder bed, scanning a laser beam on the powder bed and thereby consolidating regions of the powder bed, wherein the regions of the powder bed correspond to a cross-section of the object being fabricated.
